(19) United States
(12) Patent Application Publication
(10) Pub. No.: US 2017/0325555 A1
(43) Pub. Date: Nov. 16, 2017

(54) Decoder Ring

(71) Applicant: Edward S. Sterling, Phoenix, AZ (US)

(72) Inventor: Edward S. Sterling, Phoenix, AZ (US)

(21) Appl. No.: 13/279,992

(22) Filed: Oct. 24, 2011

(51) Int. Cl. A44C 9/00; A44C 15/00; G09C 1/04

(52) U.S. Cl. CPC A44C 9/003; G09C 1/04; A44C 9/0023; A44C 9/0053; A44C 15/00

(57) ABSTRACT

This is a particular style of decoder ring. It is based on a spinner ring that is worn on the finger. It has a band that spins, and a small window cut out of that band. The window allows characters on the surface below to be read one at a time as the window passes over them.

### BACKGROUND OF THE INVENTION

Throughout history various systems of encoding plain text have been created. Over time, the term Decoder Ring has come into use, and describes a small device that can manually encode and decode plain text. Often the term ring refers to the circular nature of the encoder. Rarely has any ring been made that is actually worn finger. In addition, there are a limited number of techniques used to encode and decode plain text on any given ring.

### SUMMARY OF THE INVENTION

This decoder ring has a band that rotates, with a small window cut out that allows characters written below to be visible one at a time.

### BRIEF DESCRIPTION OF THE SEVERAL VIEWS OF THE DRAWING

FIG. 1 is a perspective view of the complete ring;

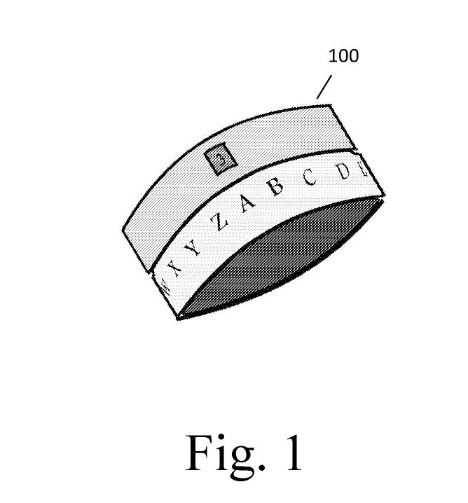

FIG. 2 is a perspective view of the two components of the ring;

FIG. 3 is a perspective view of the two components of the ring fitted together; and

FIG. 4 is a perspective view of the two components of the ring fitted together.

### DETAILED DESCRIPTION

This ring has a band that rotates, with a small window cut out that allows characters written below to be visible. The visible portion of text on the bottom half of the ring has the English alphabet around its circumference. The top half has the numbers in sequence 0-25 around its circumference. The numbers are covered by a spinning band. The spinning band has a square window cut out that allows one number at a time to be viewed as it rotates around the ring.

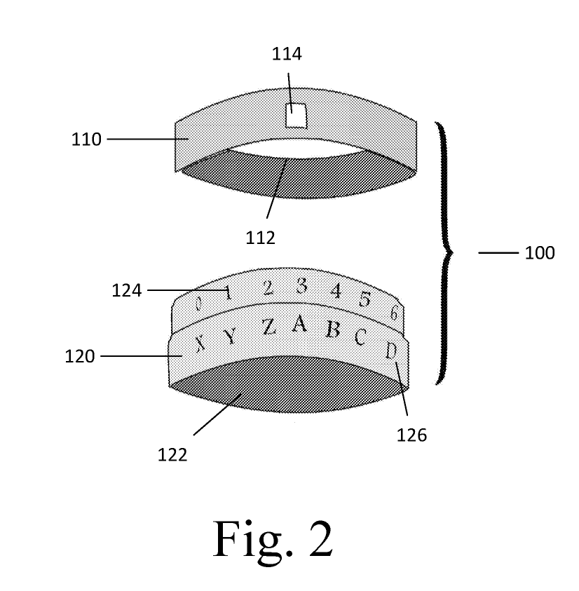

Referring to the drawings, a decoder ring 100 is disclosed. As illustrated in FIG. 2, the decoder ring 100 is comprised of an encoded band 120. The encoded band 120 has a central aperture 122 which is open to permit a user to place the decoder ring 100 on the user's finger. The encoded band 120 has a series of letters 126 on a lower portion of the encoded band 120. The encoded band 120 also has a series of numbers 124 on an upper portion of the encoded band 120. The series of letters 126 and series of numbers 124 are aligned so that each letter 126 is associated with only one number 124. In the preferred embodiment the upper portion of the encoded band 120 has a smaller outer diameter than the lower portion of the encoded band 120. The spinning band 110 has a central aperture 112 which permits the spinning band 110 to fit on the upper portion of the encoded band 120. The spinning band 110 has a window 114 cut out of the side body of the spinning band 114. In the preferred embodiment the window 114 is square in shape.

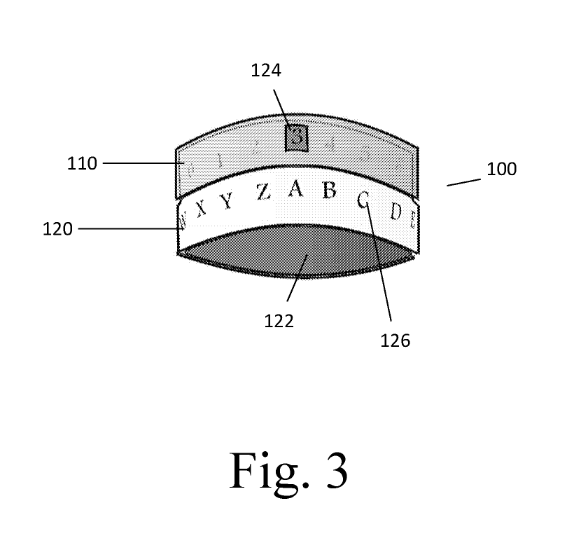

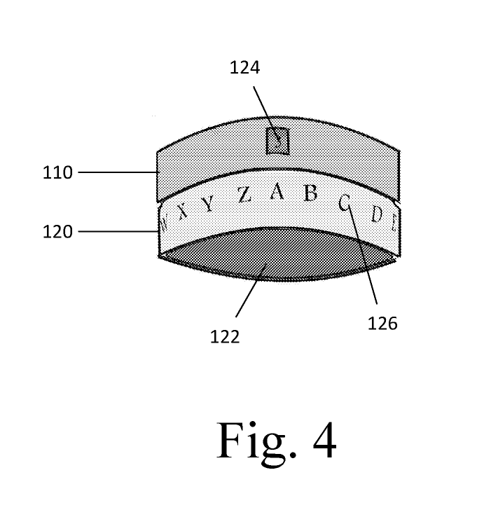

As shown in FIG. 3 and FIG. 4, the spinning band 110 fits around the outer circumference of the encoded band 120. The outer diameter of the upper portion of the encoded band 120 is such that when the spinning band 110 is fit onto the upper portion of the encoded band 120, the diameter of the spinning band 110 matches the outer diameter of the lower portion of the encoded band 120. The spinning band 110 is configured to rotate axially around the outer circumference of the upper portion of the encoded band 120. As the spinning band 110 rotates, a different number 124 is visible through the window 114. As the spinning band 110 rotates, only one number 124 is visible through the window 114.

1) (canceled)

2) A jewelry ring comprising
a) a circular encoded band having a central aperture and an outer surface area facing radially around the body of the encoded band
i) wherein said outer surface area has a top portion and a bottom portion
ii) wherein said outer surface area has a plurality of alphabetical letters positioned concentrically around a portion of said outer surface area;
iii) wherein said outer surface area has a plurality of numerical digits positioned concentrically around a portion of said outer surface area;
b) a circular spinner band having a central aperture
i) wherein said spinner band has a window aperture
ii) wherein said spinner band has an outer surface area facing radially outward from the spinner band and an inner surface area facing inward toward said central aperture of said spinner band
c) wherein said inner surface area of said circular spinner band is disposed adjacent to said top portion of said outer surface area of said encoded band;
d) wherein said spinner band is configured to rotate concentrically around said encoded band; and
e) wherein a portion of said top portion of said outer surface of said circular encoded band is viewable through said window aperture of said spinner band.

3) The jewelry ring as in claim 2
a) wherein said plurality of alphabetical letters is disposed on said bottom portion of said outer surface of said encoded band; and
b) wherein said plurality of numerical digits is disposed on said top portion of said outer surface of said encoded band.

4) The jewelry ring as in claim 3 wherein each of said plurality of alphabetical letters is disposed in line axially with only one of said plurality of numerical digits

5) The jewelry ring as in claim 4
a) wherein said plurality of alphabetical letters are spaced evenly around said bottom portion of said outer surface of said encoded band; and
b) wherein said plurality of numerical digits are spaced evenly around said top portion of said outer surface of said encoded band.

6) A method of utilizing a jewelry ring comprising
a) placing a jewelry ring on a finger, said jewelry ring comprising
i) a circular encoded band having a central aperture and an outer surface area facing radially around the body of the encoded band
(1) wherein said outer surface area has a top portion and a bottom portion
(2) wherein said outer surface area has a plurality of alphabetical letters positioned concentrically around a portion of said outer surface area;
(3) wherein said outer surface area has a plurality of numerical digits positioned concentrically around a portion of said outer surface area;
ii) a circular spinner band having a central aperture
(1) wherein said spinner band has a window aperture
(2) wherein said spinner band has an outer surface area facing radially outward from the spinner band and an inner surface area facing inward toward said central aperture of said spinner band
iii) wherein said inner surface area of said circular spinner band is disposed adjacent to said top portion of said outer surface area of said encoded band;
iv) wherein said spinner band is configured to rotate concentrically around said encoded band; and
v) wherein a portion of said top portion of said outer surface of said encoded band is viewable through said window aperture of said spinner band;
b) rotating said spinner band concentrically around said encoded band; and
c) disposing said spinner band such that a desired portion of said top portion of said outer surface of said encoded band is viewable through said window aperture.

7) The method of claim 6 further comprising disposing said spinner band such that one of said plurality of numerical digits is viewable through said window aperture.
